(19) United States
(12) Patent Application Publication
(10) Pub. No.: US 2006/0167838 A1
(43) Pub. Date: Jul. 27, 2006

(54) File-based hybrid file storage scheme supporting multiple file switches

(75) Inventor: Francesco Lacapra, Sunnyvale, CA (US)

Correspondence Address: MORGAN, LEWIS & BOCKIUS, LLP., 2 PALO ALTO SQUARE, 3000 EL CAMINO REAL, PALO ALTO, CA, 94306, US

(73) Assignee: Z-Force Communications, Inc., Santa Clara, CA (US)

(21) Appl. No.: 11/041,147

(22) Filed: Jan. 21, 2005

(51) Int. Cl. G06F 17/30

(52) U.S. Cl. 707/2

(57) ABSTRACT

In an aggregated file system, a file may begin with a set of stripe fragments all in the RAID-5 scheme in order to take advantage of the RAID-5 scheme's storage efficiency. After that, when one of the fragments is accessed by a file switch, it will be duplicated into the data mirroring scheme. The file's corresponding metadata server maintains a data structure, e.g., a bitmap, indicating which fragments have been duplicated into the data mirroring scheme. In other words, the file, at this moment, exists in a hybrid scheme. A file consolidator running on the metadata server is triggered at a predefined time to copy the fragments from the data mirroring scheme back to the RAID-5 scheme, This file consolidator also updates the bitmap to reflect the changes to the file's scheme change. This hybrid scheme is expected to increase the I/O capacity of the conventional RAID-5 scheme and the storage usage of the conventional mirroring scheme.

### RELATED APPLICATIONS

This application is related to U.S. patent application Ser. No. 10/043,413, entitled File Switch and Switched File System, filed Jan. 10, 2002, and U.S. Provisional Patent Application No. 60/261,153, entitled FILE SWITCH AND SWITCHED FILE SYSTEM and filed Jan. 11, 2001, both of which are incorporated herein by reference.

### FIELD OF THE INVENTION

The present invention relates generally to the field of storage networks, and more specifically to a file-based hybrid storage scheme supporting multiple file switches in an aggregated file system.

### BACKGROUND

An aggregated file system typically includes a large amount of data that are organized into different user files to serve multiple clients. From a client's perspective, one way to measure the performance of the aggregated file system is its file accessibility, i.e., how long it takes for the client to access a user file stored in the system. To improve file accessibility, a user file is often partitioned into multiple stripes that are allocated to different file servers such that file read or write operations can be spread across the multiple file servers and executed in a parallel fashion.

Meanwhile, it is also highly desirable for an aggregated file system to maintain a certain level of data redundancy so that an access request to a user file can still be satisfied even if one file server hosting at least a portion of the user file is temporarily taken offline. For example, the file system may choose to keep multiple identical copies of the user file or its stripes on different file servers through data mirroring. A downside of this scheme is that its disk storage efficiency per file is only 50%.

A more storage efficient approach often applied to block storage is called “Redundant Arrays of Independent Disks” level 5 (or the RAID-5) scheme. Given a user file including multiple stripes, each stripe comprising multiple data fragments, the RAID-5 scheme generates a parity fragment for each stripe through an exclusive-or operation of the data fragments and the data and parity fragments are arranged in such a manner that no two fragments are stored on the same disk or file server. Even though the RAID-5 scheme provides a higher disk storage efficiency (depending upon the number of data and parity fragments per stripe), the maintenance of a parity fragment per stripe seriously impedes certain file operations, e.g., file writes become quite expensive in a RAID-5 environment. Therefore, it is desired to have a new file storage scheme that has a per-file storage efficiency comparable to the RAID-5 scheme, but a per-file operational efficiency similar to the data mirroring scheme.

### SUMMARY

A hybrid file storage scheme is provided for managing user files in an aggregated file system. According to this hybrid file storage scheme, a user file comprises first and second sets of file segments, the first set being stored in a first array of file servers according to a first scheme and the second set being stored in a second array of file servers according to a second scheme. Upon receipt from a client of a file operating request with respect to a user file, the aggregated file system identifies the first set of file segments stored in the first array and the second set of file segments in the second array and then applies a corresponding operating instruction to the first and second sets of file segments, respectively.

In a first embodiment, a method of managing user files in an aggregated file system comprises receiving from a client a file operating request with respect to a user file, the request including a name of the user file and an operating instruction, identifying a first set of file segments of the user file stored in the aggregated file system according to a first scheme, identifying a second set of file segments of the user file stored in the aggregated file system according to a second scheme, and applying the operating instruction to the first and second sets of file segments, respectively.

In a second embodiment, an aggregated file system comprises a plurality of file servers and a file switch that includes a processor for executing instructions for storing, maintaining and providing access to a set of user files. These instructions include instructions for receiving from a client a file operating request with respect to a user file, the request including a name of the user file and an operating instruction; instructions for identifying a first set of file segments of the user file stored in the aggregated file system according to a first scheme; instructions for identifying a second set of file segments of the user file stored in the aggregated file system according to a second scheme; and instructions for applying the operating instruction to the first and second sets of file segments, respectively. For each user file, the plurality of file servers include a first array of file servers hosting the first set of file segments and a second array of file servers hosting the second set of file segments.

In a third embodiment, a file switch for use in an aggregated file system comprises at least one processing unit for executing computer programs, at least one interface for exchanging information with file servers, metadata server and client computers, a set of user files that have been updated by the file switch during a predefined time period, a request handle module for receiving a file operating request with respect to a user file, a file read module for extracting a plurality of file segments of a user file from the file servers and returning them to a requesting client, a file write module for updating a plurality of file segments of a user file in the file servers in accordance with a new version of the user file, and a file consolidate module for removing one or more user files from the set of updated user files in accordance with a predefined condition.

### BRIEF DESCRIPTION OF THE DRAWINGS

The aforementioned features and advantages of the invention as well as additional features and advantages thereof will be more clearly understood hereinafter as a result of a detailed description of embodiments of the invention when taken in conjunction with the drawings.

FIG. 1 is a diagram illustrating an exemplary network environment including an aggregated file system.

FIG. 2 is a schematic diagram illustrating a file switch of the aggregated file system that is implemented using a computer system according to one embodiment of the present invention.

FIG. 3 is a diagram illustrating a metadata file associated with a user file according to one embodiment of the present invention.

FIG. 4 is a diagram illustrating the data structure of a working set residing in a metadata server according to one embodiment of the present invention.

FIG. 5 is a flowchart illustrating the operation of a file read module operating in a file switch according to one embodiment of the present invention.

FIG. 6 is a flowchart illustrating the operation of a file write module operating in a file switch according to one embodiment of the present invention.

FIG. 7 is a flowchart illustrating how a consolidator transfers a user file from the hybrid scheme to the RAID-5 scheme according to one embodiment of the present invention.

FIGS. 8A-8D depict an example illustrating how a user file is transferred from the RAID-5 format into the hybrid format during a file active period and then back to the RAID-5 format during a file inactive period.

Like reference numerals refer to corresponding parts throughout the several views of the drawings.

### DESCRIPTION OF EMBODIMENTS

### Definitions

User File. A “user file” is a file that a client computer works with (e.g., read, write, etc). A user file may be divided into portions and stored in multiple file servers of an aggregated file system.

Stripe. In the context of a file switch, a “stripe” is a portion of a user file. In some cases, an entire user file will be contained in a single stripe. But if the file being striped becomes larger than the stripe size, an additional stripe is created. In the RAID-5 scheme, each stripe may be further divided into N stripe fragments. Among them, N−1 stripe fragments store data of the user file and one stripe fragment stores parity information based on the data.

Metadata File. In the context of a file switch, a “metadata file” is a file that contains the metadata of a user file. The properties and state information defining the layout and/or other ancillary information of the user file is called metadata. While an ordinary client may not directly access the content of a metadata file by issuing read or write operations, it nonetheless has indirect access to certain metadata stored therein, such as file layout information, file length, etc.

File Switch. A “file switch” is a device performing various file operations in accordance with client instructions. The file switch is logically positioned between a client computer and a set of file servers. To the client computer, the file switch appears to be a file server having enormous storage capacities and high throughput. To the file servers, the file switch appears to be a client computer. The file switch directs the storage of individual user files over multiple file servers, using striping to improve throughput and using mirroring to improve fault tolerance as well as throughput.

### Overview

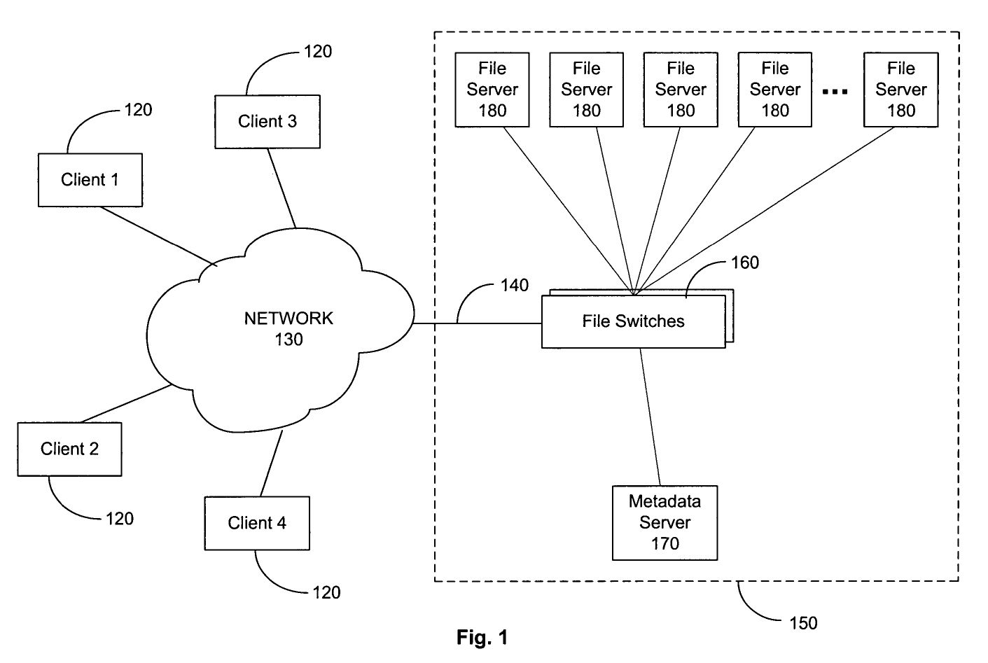

FIG. 1 illustrates an exemplary network environment including a plurality of clients 120, an aggregated file system 150 and a network 130. A client 120 typically submits to the aggregated file system 150 a file access request with respect to a particular user file through the network 130 and the aggregated file system 150 conducts certain operations to satisfy the request.

The aggregated file system 150 includes a group of file servers 180, at least one metadata server 170 and a group of file switches 160 that have communication channels with the file servers 180 and the metadata server 170, respectively. The aggregated file system 150 typically manages a large number of user files, each one having a unique file name. There are many types of user files that are used for different purposes, including user files for storing data (e.g., database files, music files, MPEGs, videos, etc) and user files that contain applications and programs used by computer users. These user files range in size from a few bytes to multiple terabytes.

Depending upon their respective purposes, different types of user files may have different accessibility requirements and therefore may need different storage schemes. For example, a website's homepage often receives multiple file read requests simultaneously. To reduce the response delay, the aggregated file system may choose the data mirroring scheme for the homepage, with multiple copies residing on different file servers. Each request for the homepage is directed by file switches to one of the file servers, which may be selected so as to balance the system's workload and improve the system's overall performance. When a file is stored using the data mirroring scheme, if one hosting file server is temporarily taken offline, a file access request can be re-directed to and served by another hosting file server. However, as mentioned above, a disadvantage of the data mirroring scheme is that its disk storage efficiency is quite low. As a result, it may not be appropriate for storing a large-volume user file.

The accessibility of a large-volume user file may be limited by the throughput of a single file server, or by the number of file servers used for hosting the user file. To improve file accessibility, a user file may be divided into multiple stripes according to a data striping scheme, e.g., the RAID-5 scheme, in which the stripes are spread across multiple file servers with each one hosting only a portion of the user file. A single access request for the user file is translated by a file switch into multiple access requests, each directed to a different hosting file server, to increase the throughput. Data redundancy in the RAID-5 scheme is achieved by generating a parity fragment for a set of data fragments within a stripe and keeping the data and parity fragments on separate file servers.

It has been observed that the RAID-5 scheme works best when most file access requests are read requests (e.g., if the user file is a read-only video stream). However, the RAID-5 scheme is less efficient if many access requests are write requests that modify at least a portion of the user file (e.g., a database file), because every write operation on a stripe requires a subsequent update of its parity fragment, thereby significantly increasing the cost associated with the write operation. Note that if the parity fragment is not updated after each associated data write operation, the data redundancy of the user file may be temporarily lost until the parity fragment is updated. In this case, temporal windows may exist such that an unrecoverable error or system crash occurring within the windows may cause some user data to be lost. Below is a table comparing the steps necessary for updating a single data fragment within a stripe using non-RAID-5 and RAID-5 data storage schemes:

| Non-RAID-5 Scheme | | RAID-5 Scheme | |
|---|---|---|---|
| a. | Retrieve the current data | a. | Retrieve the current data fragment Dᵢ; |
| | fragment Dᵢ; and | b. | Retrieve the current parity fragment |
| b. | Replace the current data | | Pᵢ; |
| | fragment Dᵢ with a new | c. | Generate a temporary parity fragment |
| | data fragment Dᵢ′. | | Tᵢ by taking the exclusive-or of Dᵢ |
| | | | and Pᵢ; |
| | | d. | Replace the current data fragment Dᵢ |
| | | | with a new data fragment Dᵢ′; |
| | | e. | Generate a new parity fragment Pᵢ′ by |
| | | | taking the exclusive-or of Tᵢ and Dᵢ′; |
| | | f. | Write the new data fragment Dᵢ′ back |
| | | | to its file server; and |
| | | g. | Write the new parity fragment Pᵢ′ |
| | | | back to its file server. |

Therefore, the number of I/O operations needed in the RAID-5 scheme is 1 (step a)+1 (step b)+1 (step f)+1 (step g)=4 while the number needed in the non-RAID-5 scheme is only 2. In other words, a RAID-5 write is at least twice as expensive as a non-RAID-5 write.

In one embodiment of the present invention, a hybrid file storage scheme is proposed that combines the benefit inherent within the data mirroring scheme and the RAID-5 scheme. According to this hybrid file storage scheme, a user file comprises two sets of file segments. One set of file segments is stored in an array of file servers according to the mirroring scheme, each segment corresponding to multiple copies of a stripe fragment on different file servers, and the other set of file segments is stored in another array of file servers according to the RAID-5 scheme, each segment including at least two data fragments and one parity fragment arranged in a round-robin fashion. The user file also has an associated metadata file stored in a metadata server and the metadata file includes data structures identifying the two arrays of hosting file servers. Upon receipt of a file operating request with respect to the user file, a file switch of the aggregated file system invokes a module to access the user file's file segments stored in the two arrays of file servers and conducts certain operations on the stripe fragments stored in the two arrays of file servers accordingly.

### System Architecture

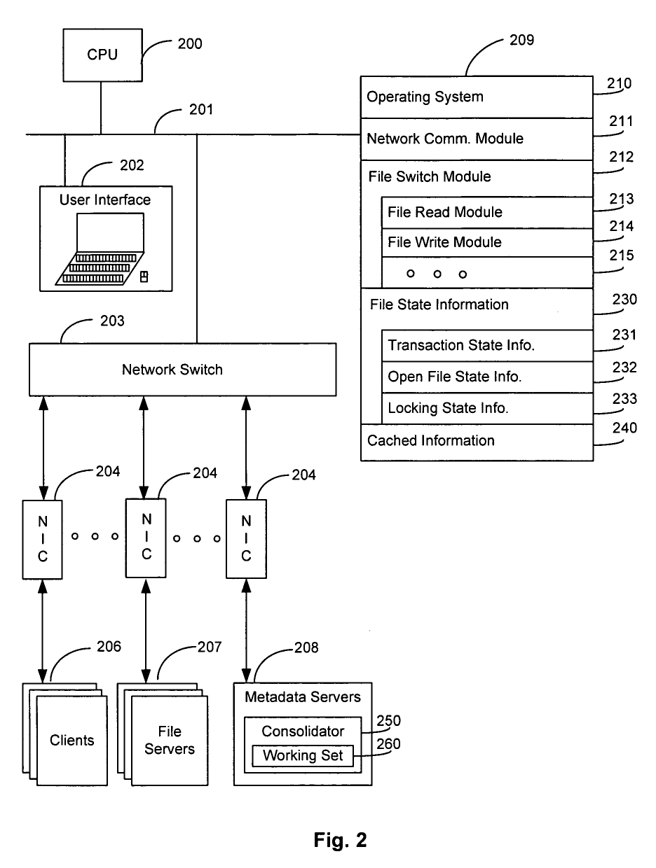

In some embodiments, a file switch 220 of the aggregated file system is implemented using a computer system schematically shown in FIG. 2. The file switch 220 comprises one or more processing units (CPUs) 200, a memory device 209, a network interface circuit 204 for coupling the file switch to a local area network or other communications network (represented in FIG. 2 by network switch 203), and one or more system buses 201 that interconnect these components. The file switch 220 may optionally have a user interface 202, although in some embodiments the file switch 220 is managed using a workstation connected to the file switch 220 via network switch 203. In alternate embodiments, much of the functionality of the file switch may be implemented in one or more application specific integrated circuits (ASICs), thereby either eliminating the need for the CPU, or reducing the role of the CPU in the handling of file access requests initiated by clients 206. The file switch 220 may be interconnected to a plurality of clients 206, file servers 207, and one or more metadata servers 208, by the network switch 203.

The memory 209 may include high speed random access memory and may also include non volatile memory, such as one or more magnetic disk storage devices. The memory 209 may include mass storage that is remotely located from the CPU 200. The memory 209 stores the following elements, or a subset of such elements:
an operating system 210 that includes procedures for handling various basic system services and for performing hardware dependent tasks;
a network communication module 211 that is used for controlling communication between the system and clients 206, file servers 207 and metadata servers 208 via the network or communication interface 204 and one or more communication networks (represented by network switch 203), such as the Internet, other wide area networks, local area networks, metropolitan area networks, or combinations of two or more of these networks;
a file switch module 212, for implementing many of the main aspects of the aggregate file system, the file switch module 212 further including a file read module 213 and a file write module 214, etc;
file state information 230, including transaction state information 231, open file state information 232 and locking state information 233; and
cached information 240 for storing metadata information of one or more user files being processed by the file switch.

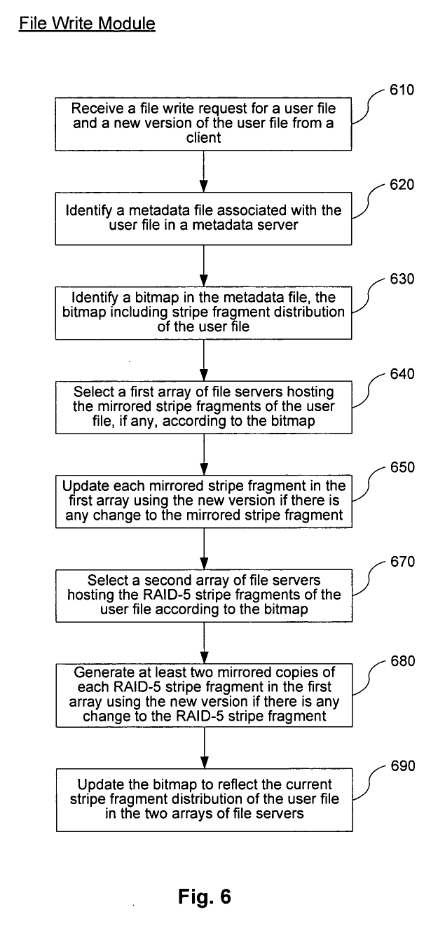

The file switch module 212, the state information 230 and the cached information 240 may include executable procedures, sub-modules, tables or other data structures. In other embodiments, additional or different modules and data structures may be used, and some of the modules and/or data structures listed above may not be used. More detailed descriptions of the file read module 213 and the file write module 214 are provided below in connection with FIGS. 5 and 6.

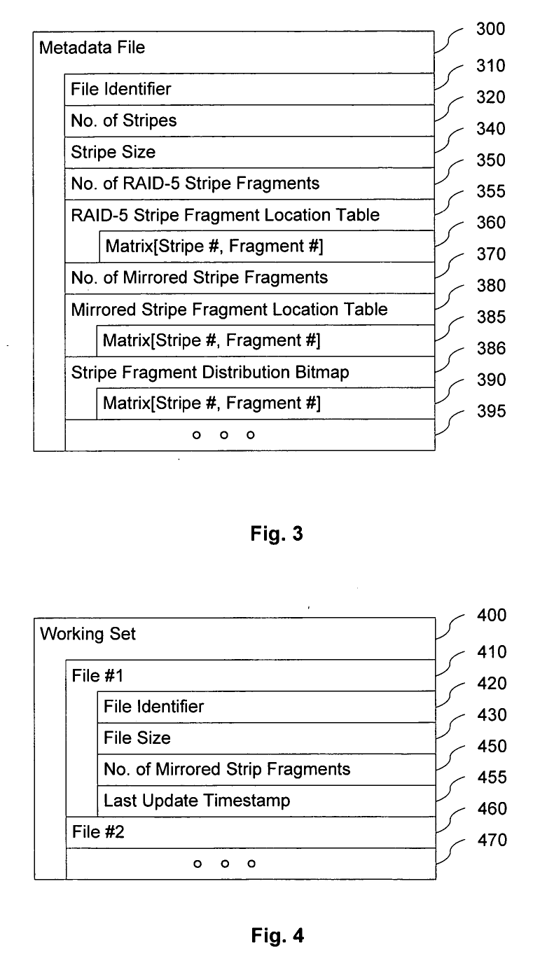

According to some embodiments, a metadata server 208 includes at least a plurality of metadata files, each metadata file associated with a user file. FIG. 3 is a diagram illustrating a metadata file associated with a user file in one of the embodiments. In some embodiments, the metadata file 300 contains the following elements:
A file identifier 310 identifying the user file with which the metadata file is associated;
A number of stripes 320 for indicating the number of stripes into which the corresponding user file has been divided;
A stripe size 340 for indicating the size (in number of bytes) of each stripe;
A number of RAID-5 stripe fragments 350 indicating the number of the stripe fragments stored in the file system according to the RAID-5 storage scheme;
A RAID-5 stripe fragment location table 355 that contains a matrix 360 of pointers to (or addresses of) the RAID-5 stripe fragments in an array of file servers;
A number of mirrored stripe fragments 370 indicating the number of the stripe fragments stored in the file system according to the mirroring storage scheme;
A mirrored stripe fragment location table 380 that contains a matrix 385 of pointers to (or addresses of) the mirrored stripe fragments in another array of file servers; and
A stripe fragment distribution bitmap 390 indicating which set of stripe fragments of the user file are stored in the RAID-5 scheme and which set of stripe fragments of the user file are stored in the mirroring scheme.

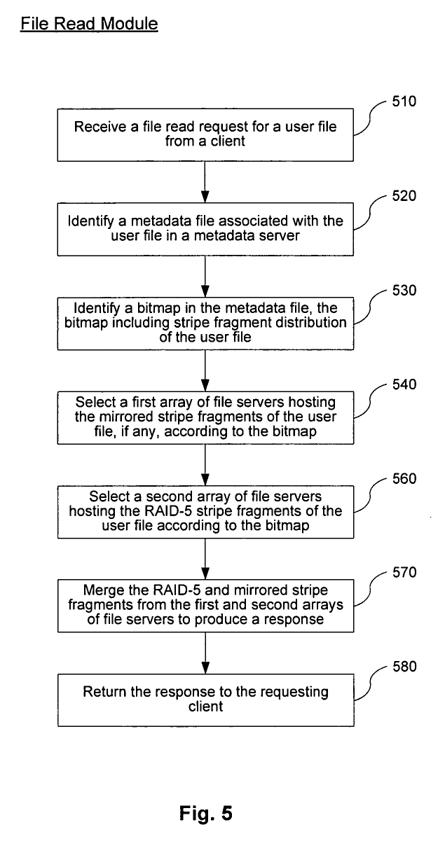

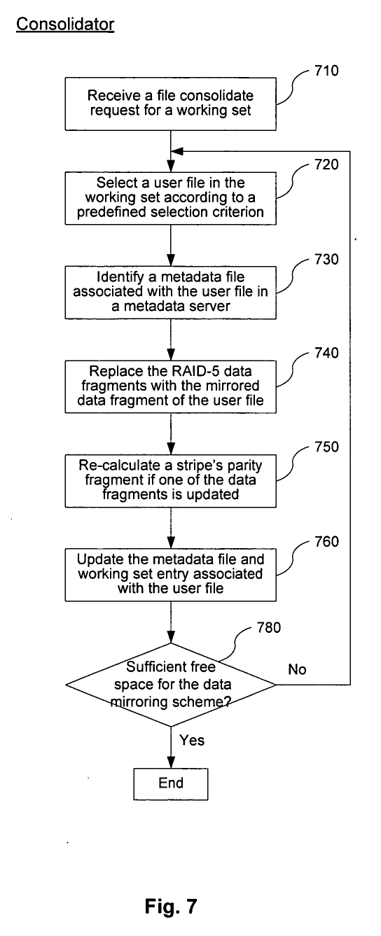

Referring again to FIG. 2, a metadata server may also include a file consolidate module (or “consolidator”) 250 and a working set 260 of user files that are stored according to the hybrid file storage scheme as an integral part of the RAID-5 scheme. In some other embodiments, the consolidator 250 may reside in the memory 209 of a file switch 220. FIG. 4 is a diagram illustrating the data structure of a working set 400. The working set includes multiple entries 410, each entry corresponding to one user file in the hybrid format. An entry like “File #1” 410-1 may include a file identifier 420, a file size 430, a number of mirrored stripe fragments 450 and a last update timestamp 455. In some embodiments, the consolidator 250 periodically summarizes the number of mirrored stripe fragments within each entry of the working set 400. From the summation results, the consolidator 250 grasps a full view of the usage of disk space reserved for the data mirroring scheme and then conditionally performs one or more disk space consolidation actions, if such actions are deemed necessary or prudent. More details about the operation of the consolidator 250 are provided below in connection with FIG. 7.

Note that the aforementioned additional I/O operations required by the RAID-5 scheme on a block-based implementation may be reduced if the parity fragments are cached in a non-volatile random access memory (NVRAM). This approach reduces the number of write operations associated with the parity fragments without creating temporal windows in which the redundancy may be lost. The data stored the NVRAM is retained even during system crashes and it can be written back to disks in the subsequent recovery phase. Since NVRAM is a centralized resource and it is inherently up to date, a parity fragment found in the NVRAM should be accessed first and the copy in the disk should be fetched (and updated if necessary) only if not found in the NVRAM.

Unfortunately, there is a challenge for directly applying the same logic mentioned above to a file-based implementation involving multiple file switches. This is because the high scalability of a file switch based system depends on the fact that multiple file switches operate independently without synchronizing with one another. If the file switches have to synchronize with each other for each cached parity fragment, the scalability of the system is greatly compromised. In contrast, the present invention is directed to a scheme that avoids synchronization of cached parity fragments and handles file updates efficiently so as to minimize delays caused by inter-file switch communications.

### Application Modules

FIG. 5 is a flowchart illustrating the operation of the file read module running in a file switch according to one embodiment of the present invention. The file switch receives a file read request with respect to a user file from a client (510). In response, the file switch first identifies a metadata file associated with the user file in a metadata server (520) and then identifies a bitmap in the metadata file (530). As shown in FIG. 3, the metadata file includes a stripe fragment distribution bitmap 386, which indicates whether the user file is in the RAID-5 format or the mirrored format or in a hybrid format, and if so, which portions are in the RAID-5 format and which portions are in the mirrored format. The file switch visits the mirrored stripe fragment location table in the metadata file to select a first array of file servers hosting the mirrored stripe fragments of the user file (540). Note that if the user file has never been updated before, or has not been updated for a long period of time, it is likely that all the stripe fragments are stored in the file system according to the RAID-5 scheme. In this scenario, task 540 becomes optional, and the file switch may skip it and jump directly to task 560. At 560, the file switch selects a second array of file servers hosting the RAID-5 stripe fragments of the user file. Note that there are a parity fragment and multiple data fragments within each RAID-5 stripe. The file switch retrieves only the data fragments (of a RAID-5 stripe fragment) during a file read operation, because the parity fragment contains redundant information of the stripe and is only used for reconstructing a missing stripe fragment. After retrieving stripe fragments from the first and second arrays of file receivers, the file switch merges the two sets of stripe fragments into a single file (570) as a response to the file read request and returns the response to the requesting client (580). In sum, the file read module is relatively simple because it does not update any of the parity fragments.

In contrast, the file write module as depicted in FIG. 6 is more complex since data fragments have to be updated or generated in the file servers hosting the mirrored stripe fragments during the file write operation. A write operation begins when the file switch receives a file write request from a client (610). The file write request is typically accompanied by a new version of the stripe fragment that includes new content provided by the client. The new version of the stripe fragment may include a combination of new content and old content already existing in the aggregated file system. The existence of any new content suggests that one or more existing data fragments of the user file will become obsolete. In particular, after an update of the user file, the obsolete data fragments remain in the RAID-S format, while the up-to-date ones may be in either format with the mirrored ones being those data fragments that have been updated. Thus the user file ends up being stored according to the hybrid scheme.

The file write module is initially similar to the file read module discussed above. For example, the file switch identifies a metadata file (620) and a stripe fragment distribution bitmap (630). If the content of the bitmap shows that all the data fragments of the user file are in RAID-S format, i.e., this is the first file write request associated with this particular user file, the file switch will skip tasks 640 and 650 and move directly to 670. Otherwise, the file switch selects a first array of file servers hosting the mirrored stripe fragments (640) and updates the content therein in accordance with the bitmap and the new version of the user file (650).

In one embodiment, for each mirrored data fragment found in the first array of file servers, the update operation 650 replaces the old content of the data fragment with the content in the new version if there is any change to the mirrored data fragment.

Note that each mirrored data fragment has a counterpart RAID-5 format data fragment when it is first generated in the first array of file servers, and the creation of the mirrored data fragment means that the content of its RAID-5 counterpart becomes stale. Therefore, any subsequent attempt to access the RAID-5 data fragment will be directed to the mirrored data fragment according to the user file's bitmap. But the stale RAID-5 data fragment in the second array of file servers remains intact until it is replaced by the mirrored data fragment in the first array of file servers. As a result, both the RAID-5 data fragment and its associated parity fragment become stale (however, they are still consistent with each other). More details about this replacement are provided below in connection with FIG. 7.

Since data fragments affected by the current file write request may include not only some mirrored data fragments but also some RAID-5 data fragments, the file switch selects a second array of file servers hosting the remaining RAID-5 data fragments of the user file according to the bitmap (670). For each affected RAID-5 data fragment, the file switch generates in the first array of file servers at least two identical copies of the data fragment containing new content derived from the new version (680). As a result, the updated user file comprises two sets of data fragments, one set in the first array of file servers according to the data mirroring scheme and another set in the second array of file servers according to the RAID-5 scheme. Finally, the file switch completes the file write operation by updating the bitmap in the associated metadata file to reflect the current stripe fragment distribution (690).

In some embodiments, the new content of the user file may be provided by the client and therefore has no counterpart data fragment in either array of file servers. In this case, the file switch identifies sufficient free space in the first array of file servers, generates new mirrored data fragments hosting the new content therein, and then updates the metadata bitmap accordingly. In other words, the second array of file servers does not yet have any information referring to the new content.

As discussed above, unlike the conventional RAID-5 file write in which every data fragment update is followed by an expensive parity fragment update, the parity fragments in the second array of file servers are no longer synchronized with the mirrored data fragments in the first array of file servers when the user file exists in the aggregated file system according to the hybrid scheme. However, the parity fragments are still in synch with their respective RAID-5 data fragments in the second array of file servers and can still be used for reconstructing any missing RAID-5 data fragment other than the ones that will be replaced by the mirrored data fragments. Therefore, a user file in the hybrid scheme employs two strategies of improving a user file's availability: (1) if a RAID-5 data fragment is unavailable, the file switch can re-build the data fragment using its sibling data and parity fragments; and (2) if one file server hosting a mirrored data fragment is down, the file switch can visit another file server hosting one of the identical copies of the data fragment. Since the data redundancy occurs at the data fragment level, not at the file level, disk storage efficiency is not seriously compromised in the hybrid scheme.

It will be understood by one skilled in the art that, in an aggregated file system that often handles simultaneous file access requests for a single user file, the file read (or write) module discussed above cannot be executed appropriately unless certain data locking mechanisms have been implemented in the file system, some of which are internally managed by the file system, while others are explicitly invoked by the client. It is also worthy of noting that a file server in the present invention may manage one or more hard disks simultaneously.

Even though a file switch only duplicates data fragments that are affected by a file write request, not the whole user file, it is conceivable that the portion of a user file in the mirrored format will grow as the cumulative number of file write requests grows over time, with more and more disk space required in the first array of file servers for hosting the mirrored data fragments. Consequently, the hybrid file storage scheme slowly converges to a conventional data mirroring scheme and the benefit offered by the hybrid scheme diminishes slowly. For example, an existing use file, after being updated repeatedly, but without any extension, may occupy a storage space having the size of the user file in addition to the parity fragments and the mirrored fragments.

On the other hand, many user files have time-varying visit frequencies. For example, a database file including stock trading information may receive many more visits when the stock market is open than when the market is closed. In many case, the life cycle of a user file can be divided into at least two periods, an active period and an inactive period. During the active period, there is a higher demand for the availability of the user file and the benefit of the hybrid scheme usually outweighs its use of additional storage space. But during inactive periods, the benefits of the hybrid scheme may be outweighed by the costs, and the file system may address this imbalance by reorganizing the user file during the inactive period.

FIG. 7 is a flowchart illustrating how a consolidator transfers a user file from the hybrid scheme to the RAID-5 scheme according to one embodiment of the present invention. In some embodiments, the consolidator is a module or program executed by a metadata server or a file switch. As shown in FIG. 3, a metadata server includes information (i.e., working set 260) identifying a set of user files that are currently stored according to the hybrid scheme. At 710, the consolidator receives a file consolidate request for the working set. In some embodiments, the file consolidate request is triggered periodically, e.g., every hour or every few hours. In some other embodiments, the file consolidate request is triggered when a predefined condition is met, e.g., when the remaining free space for the data mirroring scheme is below a predefined threshold level or when there is a timeout associated with a user file in the working set. There are also different predefined selection criteria, e.g., timestamp, file type, file size, etc., for determining which user file(s) in the working set should be consolidated. For instance, the metadata server may select for consolidation all user files with timestamps older than a predefined date, at least N files with the largest file sizes, or all user files having more than a threshold number of mirrored fragments. Alternately, the predefined selection criteria may be used to prioritize the user files in the working set for consolidation, while a separate stop condition is used to determine how many of the user files to consolidate.

After selecting a user file in the working set according to a predefined selection criterion (720), the consolidator identifies its associated metadata file in the metadata server (730). Based upon the information embedded in the metadata file, e.g., the mirrored stripe fragment distribution bitmap, the consolidator identifies one copy for each mirrored stripe fragment in the first array of file servers and uses them to replace the obsolete RAID-5 data fragments stored in the second array of file servers (740). For each RAID-5 stripe which has at least one data fragment updated, the consolidator locks the user file or a stripe of the user file and recalculates its parity fragment using the new data fragments (750). After updating the user file according to the RAID-S scheme, the consolidator updates the metadata file (760), e.g., resetting the bitmap and other relevant data structures including the two location tables, releases the mirrored data fragments of the user file and eliminates the user file's entry from the working set. As a result, the disk space no longer occupied by the user file is now released for subsequent use. Next, the consolidator checks if a predefined stop condition is met (780), e.g., there is sufficient free disk space in the file system for storing mirrored stripe fragments, or the working set is empty. If the stop condition is met, the consolidating process is terminated. If not, the consolidator returns to task 720 to process next user file in the working set until the working set is emptied or the stop condition is met. In some embodiments, the consolidator monitors the access requests for a user file it is responsible for. If there is a client request for the user file, the consolidator may relinquish its access to the user file so as to allow the client request to go through. This strategy also makes sure that a full consolidation is carried out only when the user file is no longer being accessed by any client.

### EXAMPLES

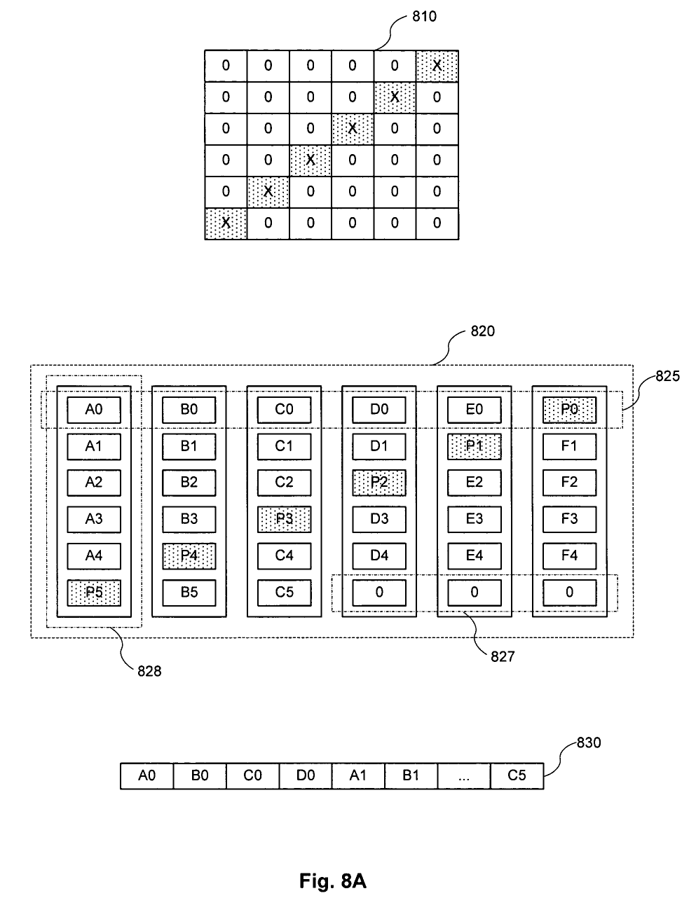

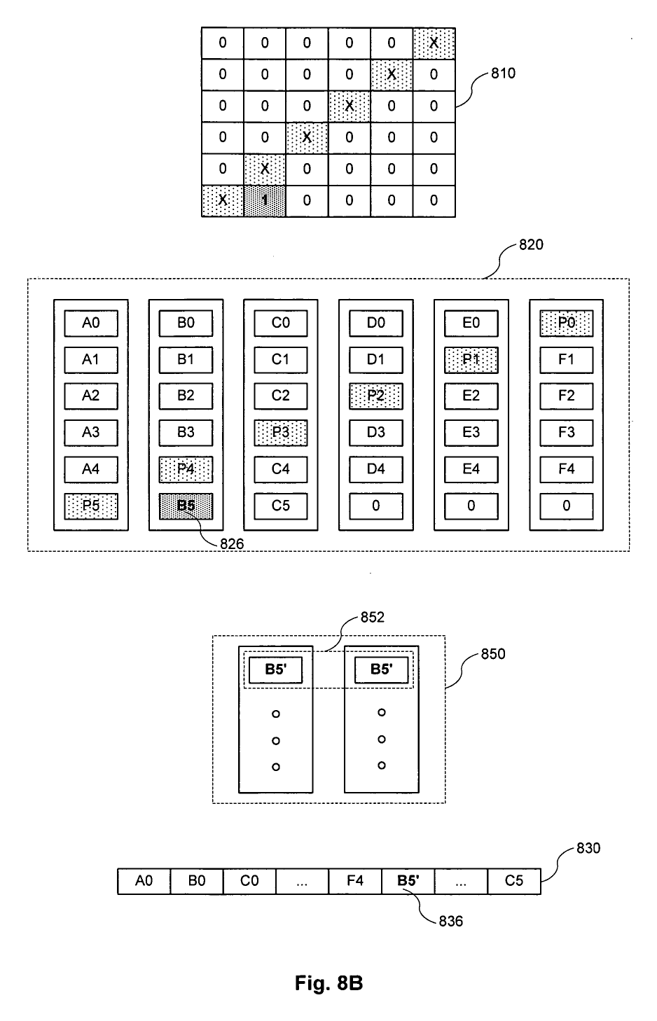

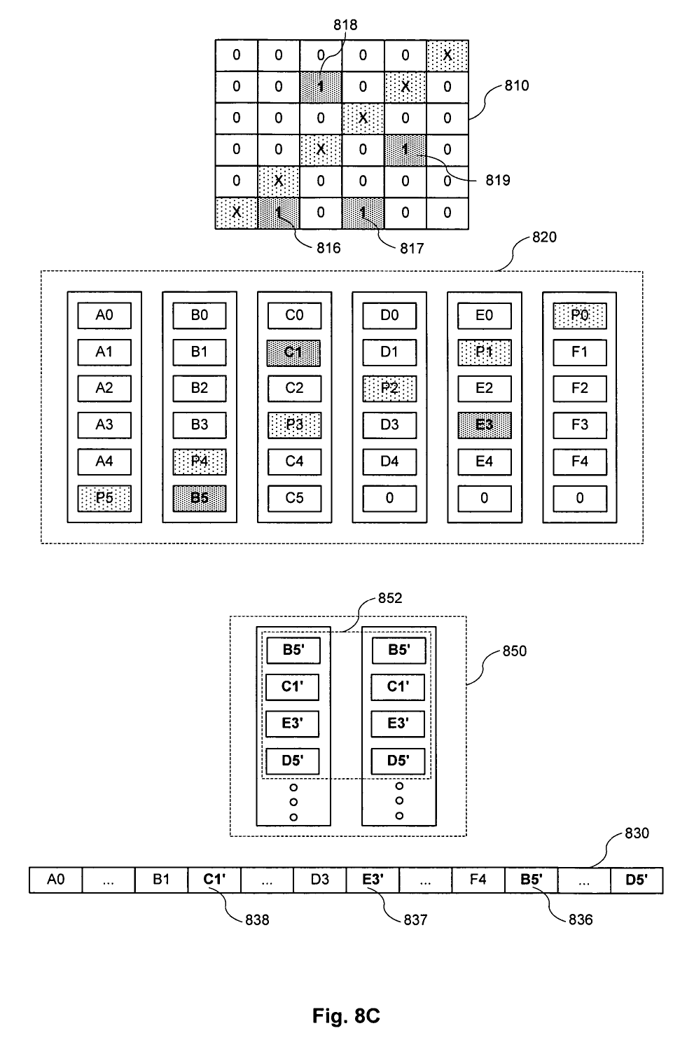

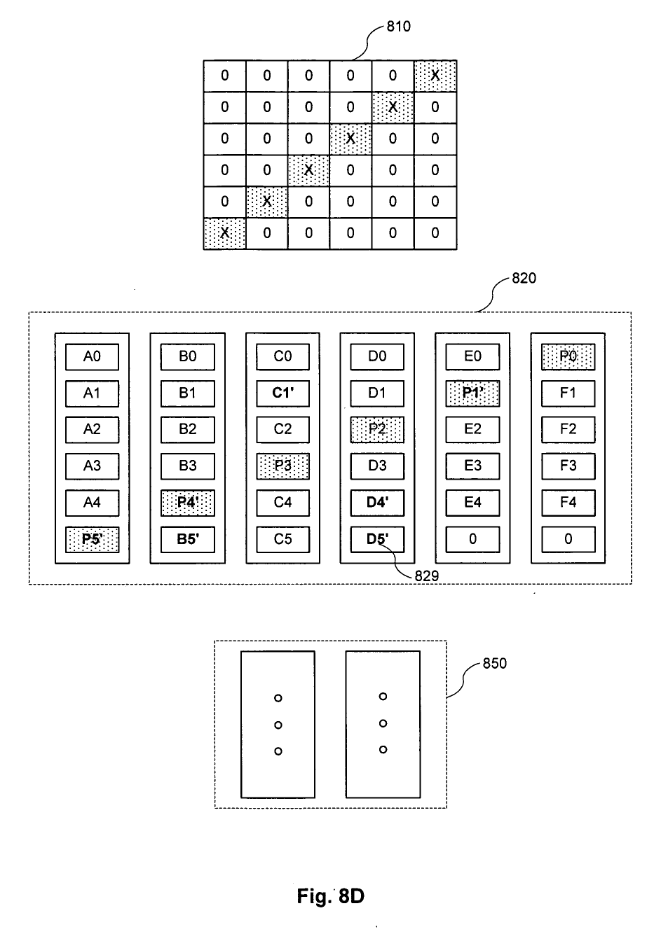

FIGS. 8A-8D depict an example illustrating how a user file is transferred from the RAID-5 scheme into the hybrid scheme in response to file write requests during a file active period and then back to the RAID-5 scheme by performing file consolidate operation during a file inactive period according to one embodiment of the present invention.

FIG. 8A shows the user file's stripe fragment distribution bitmap 810 residing in a metadata server wherein each bit associated with a data fragment of the user file stores “0” and each bit associated with a parity fragment is represented by character “X”. An array of six file servers 820 in FIG. 8A stores a copy of the user file in the RAID-5 format. The user file occupies six stripes, each stripe 825 including six stripe fragments. Each series of stripe fragments is contained in a fragment file 828 residing on one of the six file servers. Among them, five (e.g., A0-E0) are data fragments and one (e.g., P0) is a parity fragment. The six parity fragments are distributed within the file server array in a round-robin fashion and there is a one-to-one correspondence between a bit in the bitmap 810 and a stripe fragment in the file servers 820. Upon receipt of a file read request, a file switch retrieves either all or some of the data fragments from the file servers, depending on parameters of the read request, and merges them to produce a response 830. Note that the last three data fragments 827 in the last stripe are marked with “0,” suggesting that they have not been used for storing any data. Consequently, they should not be involved in the generation of the parity fragment P5.

FIG. 8B depicts the state of the user file after one file write request has been received and processed. As a result, there is one bit in the bitmap 810 flipped from 0 to 1. The corresponding data fragment 826, which is the only data fragment affected by the write request, is also highlighted in the file server array 820. However, the content of the data fragment and its associated parity fragment remain equal to “B5” and “P5”, respectively. The new content associated with the file write request as denoted by “B5” is written into multiple (i.e., two or more) copies and stored in the array of file servers 850 reserved for hosting mirrored stripe fragments. In other words, the user file has migrated from a pure RAID-5 format to a hybrid format with some file segments in the mirroring format and some other in the RAID-5 format. Accordingly, when the file switch re-assembles the user file 830 in response to a subsequent file read request, it learns from the bitmap 810 that the data fragment 826 has been updated and the current content “B5” should be retrieved from the file server array 850, not the file server array 820. Note that any subsequent file write request associated with the file segments that are already stored in the mirrored format are directed to the appropriate mirrored fragments without affecting the bitmap 810.

The bitmap 810 in FIG. 8C shows that, after the completion of another file write request, three more data fragments have been updated or generated, each one having two copies residing in two separate file servers of file server array 850. In particular, the two copies of data fragment “D5” correspond to the bit 817 in the bitmap, but its corresponding RAID-5 data fragment is still marked with “0” since the RAID-5 stripe fragment was not used for storing any data initially. Finally, as shown in FIG. 8D, the user file is transferred back from the hybrid scheme to the RAID-5 scheme by a consolidator. As a consequence, all the bits associated with user file data fragments in the bitmap 810 have a value of 0, and all the data fragments that have been updated or generated in the file server array 850 have been moved into the file server array 820 to replace their respective RAID-5 counterparts, e.g., data fragment “B5” replacing data fragment “B5” and data fragment “D5” replacing the data fragment initially marked with “0” in the stripe 827. Meanwhile, all parity fragments associated with the updated data fragments are updated, e.g., parity fragment “P1” replacing parity fragment “P1”. The stripe fragments used for storing the mirrored data fragments in the file server array 850 are also released for subsequent use.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of managing user files in an aggregated file system, comprising:
receiving from a client a file operating request with respect to a user file, the request including a name of the user file and an operating instruction;
identifying a first set of file segments of the user file stored in the aggregated file system according to a first scheme;
identifying a second set of file segments of the user file stored in the aggregated file system according to a second scheme; and
applying the operating instruction to the first and second sets of file segments, respectively.

2. The method of claim 1, wherein the user file is associated with a metadata file and the metadata file includes a data structure identifying addresses of the first and second sets of file segments in the aggregated file system.

3. The method of claim 2, wherein the data structure includes a first table identifying a first array of file servers hosting the first set of file segments and a second table identifying a second array of file servers hosting the second set of file segments.

4. The method of claim 1, wherein the first scheme is a data mirroring scheme and the second scheme is a RAID-5 scheme.

5. The method of claim 4, wherein a file segment in the first set has at least two identical copies of mirrored stripe fragments on at least two different file servers and a file segment in the second set is a RAID-5 stripe comprising at least three stripe fragments, each stored in a separate file server of the aggregated file system.

6. The method of claim 5, wherein the at least three stripe fragments include a parity fragment and at least two data fragments, and the parity fragment comprises the exclusive-or of the at least two data fragments.

7. The method of claim 6, wherein the parity fragments associated with the second set of file segments are distributed across the second array of file servers in a round-robin fashion.

8. The method of claim 5, wherein, in the case that the file operating request is a file read request, the applying the operating instruction includes:
extracting each of the mirrored stripe fragments from one of the first array of file servers;
extracting each of the RAID-5 stripe fragments from one of the second array of file servers;
merging the mirrored and RAID-5 stripe fragments to produce a response; and
returning the response to the requesting client.

9. The method of claim 5, wherein, in the case that the file operating request is a file write request associated with a new version of the user file, the applying the operating instruction includes:
updating each mirrored stripe fragment stored in one of the first array of file servers if its content is modified in the new version of the user file;
generating at least two identical copies of mirrored stripe fragments in at least two of the first array of file servers, the mirrored stripe fragments corresponding to a RAID-5 stripe fragment in the second array of file servers whose content is modified in the new version of the user file; and
changing the first and second tables in the metadata file to reflect the content changes in the new version of the user file.

10. The method of claim 5, wherein, in the case that the file operating request is a file consolidate request triggered by a timeout of the user file, the applying the operating instruction includes:
updating a RAID-5 stripe fragment stored in one of the second array of file servers with its corresponding mirrored stripe fragment stored in one of the first array of file servers;
updating a parity fragment associated with the RAID-5 stripe fragment;
repeating said two updates until all mirrored stripe fragments of the user file are stored in the second array of file servers; and
changing the first and second tables in the metadata file to release space occupied by the mirrored stripe fragments of the user file.

11. The method of claim 5, wherein, in the case that the file operating request is a file consolidate request, the applying the operating instruction includes:
selecting a user file from a set of user files in accordance with predefined selection criteria, the user file having a set of mirrored stripe fragments in the first array of file servers and an associated metadata file;
moving the mirrored stripe fragments from the first array of file servers into the second array of file servers;
updating the metadata file to reflect said moving; and
repeating said selecting, moving and updating until a stop condition is reached.

12. The method of claim 11, wherein said moving includes:
updating a RAID-5 stripe fragment stored in one of the second array of file servers with a corresponding mirrored stripe fragment stored in one of the first array of file servers;
updating a parity fragment associated with the RAID-5 stripe fragment; and
repeating said two updates until all mirrored stripe fragments of the user file are stored in the second array of file servers.

13. The method of claim 5, wherein, in the case that the file operating request is a file consolidate request triggered when free space in the first array of file servers falls below a predefined threshold level, the applying the operating instruction includes:
selecting a user file from a set of user files in accordance with its timestamp, the user file having a set of mirrored stripe fragments in the first array of file servers and an associated metadata file;
releasing space occupied by the mirrored stripe fragments by moving the mirrored stripe fragments from the first array of file servers into the second array of file servers;
updating the metadata file to reflect said releasing; and
repeating said selecting, releasing and updating until the free space in the first array of file servers is above the predefined threshold level.

14. The method of claim 13, wherein said releasing includes:
updating a RAID-5 stripe fragment stored in one of the second array of file servers with a corresponding mirrored stripe fragment stored in one of the first array of file servers;
updating a parity fragment associated with the RAID-5 stripe fragment; and
repeating said two updates until all mirrored stripe fragments of the user file are stored in the second array of file servers.

15. An aggregated file system, comprising:
a plurality of file servers;
a file switch, including:
a processor for executing instructions for storing, maintaining and providing access to a set of user files, the instructions including:
instructions for receiving from a client a file operating request with respect to a user file, the request including a name of the user file and an operating instruction;
instructions for identifying a first set of file segments of the user file stored in the aggregated file system according to a first scheme;
instructions for identifying a second set of file segments of the user file stored in the aggregated file system according to a second scheme; and
instructions for applying the operating instruction to the first and second sets of file segments, respectively;
wherein the plurality of file servers include a first array of file servers hosting the first set of file segments and a second array of file servers hosting the second set of file segments.

16. The system of claim 15, wherein the user file is associated with a metadata file and the metadata file is stored in a metadata server including a data structure identifying addresses of the first and second sets of file segments in the aggregated file system.

17. The system of claim 16, wherein the data structure includes a first table identifying the first array of file servers hosting the first set of file segments and a second table identifying the second array of file servers hosting the second set of file segments.

18. The system of claim 17, wherein the first scheme is a data mirroring scheme and the second scheme is a RAID-5 scheme.

19. The system of claim 18, wherein a file segment in the first set has at least two identical copies of mirrored stripe fragments on at least two different file servers and a file segment in the second set is a RAID-5 stripe comprising at least three stripe fragments, each stored in a separate file server of the aggregated file system.

20. The system of claim 19, wherein the at least three stripe fragments include a parity fragment and at least two data fragments, and the parity fragment comprises the exclusive-or of the at least two data fragments.

21. The system of claim 20, wherein the parity fragments associated with the second set of file segments are distributed across the second array of file servers in a round-robin fashion.

22. The system of claim 19, wherein, in the case that the file operating request is a file read request, the instructions for applying the operating instruction include:
instructions for extracting each of the mirrored stripe fragments from one of the first array of file servers;
instructions for extracting each of the RAID-5 stripe fragments from one of the second array of file servers;
instructions for merging the mirrored and RAID-5 stripe fragments to produce a response; and
instructions for returning the response to the requesting client.

23. The system of claim 19, wherein, in the case that the file operating request is a file write request associated with a new version of the user file, the instructions for applying the operating instruction include:
instructions for updating each mirrored stripe fragment stored in one of the first array of file servers if its content is modified in the new version of the user file;
instructions for generating at least two identical copies of mirrored stripe fragments in at least two of the first array of file servers, the mirrored stripe fragments corresponding to a RAID-5 stripe fragment in the second array of file servers whose content is modified in the new version of the user file; and
instructions for changing the first and second tables in the metadata file to reflect the content changes in the new version of the user file.

24. The system of claim 19, wherein, in the case that the file operating request is a file consolidate request triggered by a timeout of the user file, the instructions for applying the operating instruction include:
instructions for updating a RAID-5 stripe fragment stored in one of the second array of file servers with its corresponding mirrored stripe fragment stored in one of the first array of file servers;
instructions for updating a parity fragment associated with the RAID-5 stripe fragment;
instructions for repeating said two updates until all mirrored stripe fragments of the user file are stored in the second array of file servers; and
instructions for changing the first and second tables in the metadata file to release space occupied by the mirrored stripe fragments of the user file.

25. The system of claim 19, wherein, in the case that the file operating request is a file consolidate request, the instructions for applying the operating instruction include:
instructions for selecting a user file from a set of user files in accordance with predefined selection criteria, the user file having a set of mirrored stripe fragments in the first array of file servers and an associated metadata file;
instructions for moving the mirrored stripe fragments from the first array of file servers into the second array of file servers;
instructions for updating the metadata file to reflect said moving; and
instructions for repeating said selecting, moving and updating until a stop condition is reached.

26. The system of claim 25, wherein said moving instructions include:
instructions for updating a RAID-5 stripe fragment stored in one of the second array of file servers with a corresponding mirrored stripe fragment stored in one of the first array of file servers;
instructions for updating a parity fragment associated with the RAID-5 stripe fragment; and
instructions for repeating said two updates until all mirrored stripe fragments of the user file are stored in the second array of file servers.

27. The system of claim 19, wherein, in the case that the file operating request is a file consolidate request triggered when free space in the first array of file servers falls below a predefined threshold level, the instructions for applying the operating instruction include:
instructions for selecting a user file from a set of user files in accordance with its timestamp, the user file having a set of mirrored stripe fragments in the first array of file servers and an associated metadata file;
instructions for releasing space occupied by the mirrored stripe fragments by moving the mirrored stripe fragments from the first array of file servers into the second array of file servers;
instructions for updating the metadata file to reflect said releasing; and
instructions for repeating said selecting, releasing and updating until the free space in the first array of file servers is above the predefined threshold level.

28. The system of claim 27, wherein said releasing instructions include:
instructions for updating a RAID-5 stripe fragment stored in one of the second array of file servers with a corresponding mirrored stripe fragment stored in one of the first array of file servers;
instructions for updating a parity fragment associated with the RAID-5 stripe fragment; and
instructions for repeating said two updates until all mirrored stripe fragments of the user file are stored in the second array of file servers.

29. A file switch for use in a computer network having a plurality of file servers, a metadata server and a plurality of client computers, the file switch comprising:
at least one processing unit for executing computer programs;
at least one interface for exchanging information with the file servers, metadata server and client computers, the information exchanged including information concerning a specified user file;
a set of user files that have been updated by the file switch during a predefined time period;
instructions for receiving a file operating request with respect to a user file, the request including a name of the user file and an operating instruction;
file read instructions for extracting a plurality of file segments of a user file from the file servers and returning them to a requesting client;
file write instructions for updating a plurality of file segments of a user file in the file servers in accordance with a new version of the user file; and
file consolidate instructions for removing one or more user files from the set of updated user files in accordance with a predefined condition.

30. The file switch of claim 29, wherein each of the file read instructions, file write instructions and file consolidate instructions includes:
instructions for identifying a first set of file segments of a user file stored in a first array of file servers of the aggregated file system according to a first scheme; and
instruction for identifying a second set of file segments of a user file stored in a second array of file servers of the aggregated file system according to a second scheme.

31. The file switch of claim 30, wherein the user file is associated with a metadata file stored in the metadata server and the metadata file includes first and second tables identifying addresses of the first and second sets of file segments in the first and second arrays of file servers.

32. The file switch of claim 31, wherein the first scheme is a data mirroring scheme and the second scheme is a RAID-5 scheme.

33. The file switch of claim 32, wherein the file read module includes:
instructions for extracting a plurality of mirrored stripe fragments from the first array of file servers;
instructions for extracting a plurality of RAID-5 stripe fragments from the second array of file servers;
instructions for merging the mirrored and RAID-5 stripe fragments to produce a response; and
instructions for returning the response to the requesting client.

34. The file switch of claim 32, wherein the file write module includes, upon receipt of a new version of the user file:
instructions for updating a mirrored stripe fragment in one of the first array of file servers in accordance with the new version of the user file;
instructions for generating at least two copies of a RAID-5 stripe fragment in at least two file servers in the first array of file servers in accordance with the new version of the user file; and
instructions for changing the first and second tables in the metadata file to reflect the content changes in the new version of the user file.

35. The file switch of claim 32, wherein, if the predefined condition is a timeout of a user file, the file consolidate module includes:
instructions for updating a RAID-5 stripe fragment stored in the second array of file servers with its corresponding mirrored stripe fragment in the first array of file servers;
instructions for updating a parity stripe fragment associated with the RAID-5 stripe fragment stored in the second array of file servers; and
instructions for changing the first. and second tables in the metadata file to reflect the consolidation of the user file.

36. The file switch of claim 32, wherein, if the predefined condition is that free space in the first array for hosting mirrored stripe fragments is below a predefined threshold level, the file consolidate module includes:
instructions for selecting a user file from the set of updated user files in accordance with its updating timestamp, the user file having a set of mirrored stripe fragments in the first array of file servers;
instructions for releasing the space occupied by the mirrored stripe fragments by moving them from the first array into the second array;
instructions for updating the user file's metadata file to reflect said moving; and
instructions for repeating said selecting, releasing and updating instructions until the free space in the first array is above the predefined threshold level.

37. The file switch of claim 36, wherein said releasing instructions include:
instructions for updating a RAID-5 stripe fragment stored in one of the second array of file servers with a corresponding mirrored stripe fragment stored in one of the first array of file servers; and
instructions for updating a parity fragment associated with the RAID-5 stripe fragment; and
instructions for repeating said two updates until all mirrored stripe fragments are stored in the second array of file servers.

38. A hybrid file storage scheme for managing user files in an aggregated file system, comprising:
splitting a user file into first and second sets of file segments;
storing the first set of file segments in a first array of file servers according to a first scheme; and
storing the second set of file segments in a second array of file servers according to a second scheme.

39. The scheme of claim 38, wherein the first scheme is a data mirroring scheme and the second scheme is a RAID-5 scheme.

40. The scheme of claim 39, wherein a file segment in the first set includes at least two identical copies of a mirrored stripe fragment stored in at least two different file servers in the first array and a file segment in the second set comprises at least three stripe fragments including at least two data fragments and one associated parity fragment, each stored in a separate file server in the second array, and wherein the associated parity fragment is equal to the exclusive-or of the at least two data fragments and a mirrored stripe fragment in the first set is associated with a data fragment in the second set.
